(19) United States
(12) Patent Application Publication
(10) Pub. No.: US 2026/0015556 A1
(43) Pub. Date: Jan. 15, 2026

(54) LAUNDRY ADDITIVE INCLUDING PERFUME, BACTERIAL SPORES AND ENZYMES

(71) Applicant: The Procter & Gamble Company, Cincinnati, OH (US)

(72) Inventors: Jonathan Richard CLARE, Tervuren (BE); Neil Joseph LANT, Newcastle upon Tyne (GB); Katherine Esther LATIMER, Newcastle upon Tyne (GB); Samuel Kimani NJOROGE, Montgomery, OH (US)

(21) Appl. No.: 19/269,561

(22) Filed: Jul. 15, 2025

(30) Foreign Application Priority Data
Jul. 15, 2024 (EP) 24188552.4

(51) Int. Cl. C11D 3/38; C11D 3/22; C11D 3/37; C11D 3/50; C11D 17/00; C11D 17/06

(52) U.S. Cl. CPC C11D 3/381; C11D 3/228; C11D 3/3707; C11D 3/505; C11D 17/0039; C11D 17/06

(57) ABSTRACT

Particulate laundry additive composition having a plurality of particles wherein each of said particles has a mass between about 1 mg to about 5000 mg, the composition including:
i) at least about 60% by weight of the composition of particle A, wherein particle A includes at least 40% by weight of the particle of a carrier, from about 0.1% to about 10% by weight of the particle of perfume and the particle is substantially free of Bacillus spores and enzymes; and
ii) at least about 2% by weight of the composition of particle B, wherein particle B includes at least about 40% by weight of the particle of a carrier, from about 0.0001% to about 5% by weight of the particle of Bacillus spores and enzymes and less than about 0.01% by weight of the particle of perfume.

### FIELD OF THE INVENTION

The present invention is in the field of particulate laundry additives. In particular, the invention relates to particulate laundry additives comprising two types of particles. The first type comprising perfume and being substantially free of bacterial spores and substantially free of enzymes and the second type comprising bacterial spores and enzymes and being substantially free of perfume.

### BACKGROUND OF THE INVENTION

The present invention addresses the challenge of developing a laundry additive that imparts a pleasant smell to laundered fabrics and effectively combat malodours and aid with the cleaning during, in between and in subsequent cleaning processes, i.e., keeps the fabrics fresher for longer. The inclusion of enzymes and bacterial spores in the additive can offer malodour control and cleaning benefits. However, a critical issue arises as the enzymes and spores can negatively interact with perfume, resulting in undesirable discoloration of the additive. This discoloration adversely impacts consumer perception and acceptance, as consumers prefer products to maintain their original appearance without any discoloration.

The problem to be solved, therefore, is to create a laundry additive that harnesses the synergistic benefits of perfume, enzymes and bacterial spores while effectively managing the negative interaction between the components. The solution should ensure that the additive retains its desired visual appeal, meeting consumer expectations and enhancing overall consumer satisfaction.

### SUMMARY OF THE INVENTION

According to a first aspect of the invention, there is provided a particulate laundry additive composition. The composition comprises a plurality of particles, each particle having a mass between about 1 mg to about 5000 mg, preferably between about 5 mg and about 200 mg. The composition comprises two types of particles: particle A and particle B. Particle A comprises a carrier and perfume and is substantially free of Bacillus spores and enzymes. Particle B comprises a carrier, Bacillus spores and enzymes and is substantially free of perfume. The particles comprise: at least 40%, preferably from about 45% to about 99.99% by weight of said particles of a carrier; particle A comprises from 0.1% to 10%, preferably from 1% to 5% by weight of particle A of perfume. Particle B comprises from about 0.0001% to about 5% of Bacillus spores and enzymes, preferably from about 0.001% to about 4%, preferably from about 0.001% to about 2% by weight of particle B of enzymes. Particle B preferably comprise from 1×10³ to 1×10¹¹ CFU/g of the particle of Bacillus spores, more preferably from 1×10⁴ to 1×10¹⁰ CFU/g of the particle of Bacillus spores.

According to the second aspect of the invention, there is provided a product comprising a container comprising the composition of the invention.

According to the third aspect of the invention, there is provided a process for treating soiled laundry articles comprising the steps of:
treating the articles with a detergent composition; and
treating the articles with the composition of the invention.

The spores seem to deposit on the laundry articles during the wash and in the presence of heat seem to germinate and to reduce malodor. The spores seem to be very useful in the case of, for example, sweaty items, that have been washed with the composition of the invention. The spores seem to germinate in the presence of the complex soils produced during sweating and by the heat produced, the spores reduce the malodor.

According to the fourth and fifth aspects of the invention, there is provided the use of the laundry additive of the invention to reduce malodors from fabrics and/or to improve easiness of laundering.

The elements of the composition of the invention described in relation to the first aspect of the invention apply mutatis mutandis to the other aspects of the invention.

### DETAILED DESCRIPTION OF THE INVENTION

All percentages, ratios and proportions used herein are by weight percent of the composition, unless otherwise specified. All average values are calculated “by weight” of the composition, unless otherwise expressly indicated. All ratios are calculated as a weight/weight level, unless otherwise specified.

All measurements are performed at 25° C. unless otherwise specified.

Unless otherwise noted, all component or composition levels are in reference to the active portion of that component or composition, and are exclusive of impurities, for example, residual solvents or by-products, which may be present in commercially available sources of such components or compositions.

### Laundry Additive Composition

Laundry additive refers to a supplementary product or substance designed to enhance the cleaning performance and overall effectiveness of laundry detergents and/or fabric care products. It is specifically formulated to be used in conjunction with regular laundry detergents and/or fabric softeners to provide additional benefits such as stain removal, odor control, fabric freshness, color protection, or specialized treatments for specific fabric types. Laundry additives can come in various forms, including liquids, powders, capsules, or beads, and are typically added to the washing machine or directly to the laundry load during the washing process. These additives are intended to complement the primary cleaning agents and enhance the overall results and properties of the laundry process. The laundry additive of the present invention is in the form of particles, also referred to as “beads”. The laundry additive of the present invention helps not only with cleaning and freshness during the laundry but also in between laundry processes and also facilitates cleaning in subsequent laundry operations.

### Particle A

The laundry additive of the invention comprises at least 60%, preferably at least 70%, preferably at least 80%, preferably at least 90% and more preferably at least 95% by weight of the composition of particle A.

Particle A comprises at least 40%, preferably at least 80%, preferably at least 90%, more preferably at least 95% by weight of particle A of a carrier, from 0.1% to 10% by weight of the particle of perfume and the particle is substantially free of spores and enzymes. By “substantially free of bacterial spores and enzymes” is herein meant that neither Bacillus spores nor enzymes have been purposely added to particle A. Particle A comprises less than 0.00001% by weight of the particle of Bacillus spores and enzymes.

### Particle B

The laundry additive composition of the invention comprises at least 2%, preferably at least 3%, preferably at least 4%, preferably at least 5% by weight of the composition of particle B.

Particle B comprises at least 95%, preferably at least 96%, preferably at least 98%, more preferably at least 99% by weight of particle B of a carrier. Particle B comprises at least 40% by weight of the particle of a carrier, from about 0.0001% to about 5% by weight of the particle of Bacillus spores and enzymes and less than 0.01% by weight of the particle of perfume. Particle B comprises from about 0.0005% to about 5%, preferably from about 0.0005% to about 2% by weight of particle B of enzymes and from about 1×10³, preferably from about 1×10⁴ to about 1×10¹¹, preferably 1×10¹⁰ CFU/g of Bacillus spores by weight of particle B.

The carrier of particle A and particle B can be the same carrier. The carrier of particle A and particle B can be different carriers. Preferable the carrier is water-soluble.

The laundry additive could have three types of particles, particles comprising perfume, particles comprising enzymes and particles comprising enzymes, however, it is better from a manufacturing viewpoint to have the enzymes and the bacterial spores in the same particle. To have the enzyme and bacterial spores in the same particle can help to prevent and/or reduce segregation issues and it can help with freshness and stain removal/prevention.

### Bacterial Spores

Some gram-positive bacteria have a two-stage lifecycle in which growing bacteria under certain conditions such as in response to nutritional deprivation can undergo an elaborate developmental program leading to spores or endospores formation. The bacterial spores are protected by a coat consisting of about 60 different proteins assembled as a biochemically complex structure with intriguing morphological and mechanical properties. The protein coat is considered a static structure that provides rigidity and mainly acting as a sieve to exclude exogenous large toxic molecules, such as lytic enzymes. Spores play critical roles in long term survival of the species because they are highly resistant to extreme environmental conditions. Spores are also capable of remaining metabolically dormant for years. Methods for obtaining bacterial spores from vegetative cells are well known in the field. In some examples, vegetative bacterial cells are grown in liquid medium. Beginning in the late logarithmic growth phase or early stationary growth phase, the bacteria may begin to sporulate. When the bacteria have finished sporulating, the spores may be obtained from the medium, by using centrifugation for example. Various methods may be used to kill or remove any remaining vegetative cells. Various methods may be used to purify the spores from cellular debris and/or other materials or substances. Some example methods for producing bacterial spores are described in Example 1 of EP3819361 A1. Bacterial spores may be differentiated from vegetative cells using a variety of techniques, like phase-contrast microscopy, automated scanning microscopy, high resolution atomic force microscopy or tolerance to heat, for example.

Because bacterial spores are generally environmentally-tolerant structures that are metabolically inert or dormant, they are readily chosen to be used in commercial microbial products. Despite their ruggedness and extreme longevity, spores can rapidly respond to the presence of small specific molecules known as germinants that signal favorable conditions for breaking dormancy through germination, an initial step in the process of completing the lifecycle by returning to vegetative bacteria. For example, the commercial microbial products may be designed to be dispersed into an environment where the spores encounter the germinants present in the environment, to germinate into vegetative cells and perform an intended function. A variety of different bacteria may form spores. For example, some bacteria of the following genera may form endospores: Acetonema, Alkalibacillus, Ammoniphilus, Amphibacillus, Anaerobacter, Anaerospora, Aneurinibacillus, Anoxybacillus, Bacillus, Brevibacillus, Caldanaerobacter, Caloramator, Caminicella, Cerasibacillus, Clostridium, Clostridiisalibacter, Cohnella, Dendrosporobacter, Desulfotomaculum, Desulfosporomusa, Desulfosporosinus, Desulfovirgula, Desulfunispora, Desulfurispora, Filifactor, Filobacillus, Gelria, Geobacillus, Geosporobacter, Gracilibacillus, Halonatronum, Heliobacterium, Heliophilum, Laceyella, Lentibacillus, Lysinibacillus, Mahella, Metabacterium, Moorella, Natroniella, Oceanobacillus, Orenia, Ornithinibacillus, Oxalophagus, Oxobacter, Paenibacillus, Paraliobacillus, Pelospora, Pelotomaculum, Piscibacillus, Planifilum, Pontibacillus, Propionispora, Salinibacillus, Salsuginibacillus, Seinonella, Shimazuella, Sporacetigenium, Sporoanaerobacter, Sporobacter, Sporobacterium, Sporohalobacter, Sporolactobacillus, Sporomusa, Sporosarcina, Sporotalea, Sporotomaculum, Syntrophomonas, Syntrophospora, Tenuibacillus, Tepidibacter, Terribacillus, Thalassobacillus, Thermoacetogenium, Thermoactinomyces, Thermoalkalibacillus, Thermoanaerobacter, Thermoanaeromonas, Thermobacillus, Thermoflavimicrobium, Thermovenabulum, Tuberibacillus, Virgibacillus, and/or Vulcanobacillus.

The spores in particle B are from the genus Bacillus. In various examples, the Bacillus bacteria may be strains of Bacillus alcalophilus, Bacillus alvei, Bacillus aminovorans, Bacillus amyloliquefaciens, Bacillus aneurinolyticus, Bacillus aquaemaris, Bacillus atrophaeus, Bacillus boroniphilius, Bacillus brevis, Bacillus caldolyticus, Bacillus centrosporus, Bacillus cereus, Bacillus circulans, Bacillus coagulans, Bacillus firmus, Bacillus flavothermus, Bacillus fusiformis, Bacillus globigii, Bacillus infernus, Bacillus larvae, Bacillus laterosporus, Bacillus lentus, Bacillus licheniformis, Bacillus megaterium, Bacillus mesentericus, Bacillus mucilaginosus, Bacillus mycoides, Bacillus natto, Bacillus pantothenticus, Bacillus polymyxa, Bacillus pseudoanthracis, Bacillus pumilus, Bacillus schlegelii, Bacillus sphaericus, Bacillus sporothermodurans, Bacillus stearothermophillus, Bacillus subtilis, Bacillus thermoglucosidasius, Bacillus thuringiensis, Bacillus vulgatis, Bacillus weihenstephanensis, or combinations thereof.

In some examples, the bacterial strains that form spores may be strains of Bacillus, including: Bacillus sp. strain SD-6991; Bacillus sp. strain SD-6992; Bacillus sp. strain NRRL B-50606; Bacillus sp. strain NRRL B-50887; Bacillus pumiluss train NRRL B-50016; Bacillus amyloliquefaciens strain NRRL B-50017; Bacillus amyloliquefaciens strain PTA-7792 (previously classified as Bacillus atrophaeus); Bacillus amyloliquefaciens strain PTA-7543 (previously classified as Bacillus atrophaeus); Bacillus amyloliquefaciens strain NRRL B-50018; Bacillus amyloliquefaciens strain PTA-7541; Bacillus amyloliquefaciens strain PTA-7544; Bacillus amyloliquefaciens strain PTA-7545; Bacillus amyloliquefaciens strain PTA-7546; Bacillus subtilis strain PTA-7547; Bacillus amyloliquefaciens strain PTA-7549; Bacillus amyloliquefaciens strain PTA-7793; Bacillus amyloliquefaciens strain PTA-7790; Bacillus amyloliquefaciens strain PTA-7791; Bacillus subtilis strain NRRL B-50136 (also known as DA-33R, ATCC accession No. 55406); Bacillus amyloliquefaciens strain NRRL B-50141; Bacillus amyloliquefaciens strain NRRL B-50399; Bacillus licheniformis strain NRRL B-50014; Bacillus licheniformis strain NRRL B-50015; Bacillus amyloliquefaciens strain NRRL B-50607; Bacillus subtilis strain NRRL B-50147 (also known as 300R); Bacillus amyloliquefaciens strain NRRL B-50150; Bacillus amyloliquefaciens strain NRRL B-50154; Bacillus megateriumPTA-3142; Bacillus amyloliquefaciens strain ATCC accession No. 55405 (also known as 300); Bacillus amyloliquefaciens strain ATCC accession No. 55407 (also known as PMX); Bacillus pumilus NRRL B-50398 (also known as ATCC 700385, PMX-1, and NRRL B-50255); Bacillus cereus ATCC accession No. 700386; Bacillus thuringiensis ATCC accession No. 700387 (all of the above strains are available from Novozymes, Inc., USA); Bacillus amyloliquefaciens FZB24 (e.g., isolates NRRL B-50304 and NRRL B-50349 TAEGRO® from Novozymes), Bacillus subtilis (e.g., isolate NRRL B-21661 in RHAPSODY®, SERENADE® MAX and SERENADE® ASO from Bayer CropScience), Bacillus pumilus (e.g., isolate NRRL B-50349 from Bayer CropScience), Bacillus amyloliquefaciens TrigoCor (also known as “TrigoCor 1448”; e.g., isolate Embrapa Trigo Accession No. 144/88.4Lev, Cornell Accession No.Pma007BR-97, and ATCC accession No. 202152, from Cornell University, USA) and combinations thereof.

In some examples, the bacterial strains that form spores may be strains of Bacillus amyloliquefaciens. For example, the strains may be Bacillus amyloliquefaciens strain PTA-7543 (previously classified as Bacillus atrophaeus), and/or Bacillus amyloliquefaciens strain NRRL B-50154, Bacillus amyloliquefaciens strain PTA-7543 (previously classified as Bacillus atrophaeus), Bacillus amyloliquefaciens strain NRRL B-50154, or from other Bacillus amyloliquefaciens organisms.

The Bacillus spores may have an average particle diameter of about 2-50 microns, suitably about 10-45 microns. Bacillus spores are commercially available in blends in aqueous carriers and are insoluble in the aqueous carriers. Other commercially available bacillus spore blends include without limitation Freshen Free™ CAN (10×), available from Novozymes Biologicals, Inc.; Evogen® Renew Plus (10×), available from Genesis Biosciences, Inc.; and Evogen® GT (10×, 20× and 110×), all available from Genesis Biosciences, Inc. In the foregoing list, the parenthetical notations (10×, 20×, and 1 1 O×) indicate relative concentrations of the Bacillus spores.

Bacterial spores used in the compositions, methods, and products disclosed herein may or may not be heat activated. In some examples, the bacterial spores are heat activated. In some examples, the bacterial spores are not heat inactivated.

For the compositions disclosed here, populations of bacterial spores are generally used. In some examples, a population of bacterial spores may include bacterial spores from a single strain of bacterium. In some examples, a population of bacterial spores may include bacterial spores from 2, 3, 4, 5, or more strains of bacteria. Generally, a population of bacterial spores contains a majority of spores and a minority of vegetative cells. In some examples, a population of bacterial spores does not contain vegetative cells. In some examples, a population of bacterial spores may contain less than about 1%, 2%, 3%, 4%, 5%, 6%, 7%, 8%, 9%, 10%, 15%, 20%, 25%, 30%, 40%, or 50% vegetative cells, where the percentage of bacterial spores is calculated as ((vegetative cells/(spores in population+vegetative cells in population))×100). Generally, populations of bacterial spores used in the disclosed compositions are stable (i.e. not undergoing germination), with at least some individual spores in the population capable of germinating.

Populations of bacterial spores used in this disclosure may contain bacterial spores at different concentrations. In various examples, populations of bacterial spores may contain, without limitation, at least 1×10², 5×10², 1×10³, 5×10³, 1×10⁴, 5×10⁴, 1×10⁵, 5×10⁵, 1×10⁶, 5×10⁶, 1×10⁷, 5×10⁷, 1×10⁸, 5×10⁸, 1×10⁹, 5×10⁹, 1×10¹⁰, 5×10¹⁰, 1×10¹¹, 5×10¹¹, 1×10¹², 5×10¹², 1×10¹³, 5×10¹³, 1×10¹⁴, or 5×10¹⁴ spores/ml or spores/cm³.

For any of the compositions disclosed herein, individual particles can have a mass of from about 1 mg to about 5000 mg, alternatively from about 5 mg to about 1000 mg, alternatively from about 5 mg to about 200 mg, alternatively from about 10 mg to about 100 mg, alternatively from about 20 mg to about 50 mg, alternatively from about 35 mg to about 45 mg, alternatively about 38 mg, alternatively combinations thereof and any whole numbers or ranges of whole numbers of mg within any of the aforementioned ranges. Particles having a mass in the aforesaid ranges can have dissolution times in water that permit the particles to dissolve during a typical wash cycle. In a plurality of particles, individual particles can have a shape selected from the group consisting of spherical, hemispherical, compressed hemispherical, lentil shaped, and oblong.

The plurality of particles can have a mean particle mass of from about 1 mg to about 5000 mg, alternatively from about 5 mg to about 1000 mg, alternatively from about 5 mg to about 200 mg, alternatively from about 10 mg to about 100 mg, alternatively from about 20 mg to about 50 mg, alternatively from about 35 mg to about 45 mg, alternatively about 38 mg. The plurality of particles can have standard deviation of mass of less than about 30 mg, alternatively less than about 15 mg, alternatively less than about 5 mg, alternatively about 3 mg. The mean particle of mass within the aforesaid ranges can provide for a dissolution time in water that permits the particles to dissolve during a typical wash cycle. Without being bound by theory, it is thought that particles have such a standard deviation of mass can have a more uniform dissolution time in water as compared to particles having a broader standard deviation of mass. The smaller the standard deviation of mass of the particles the more uniform the dissolution time. The mass of the individual particles forming the plurality particles can be set to provide the desired dissolution time, which might be some fraction of the length of the typical washing cycle in a washing machine. Particles formed from polyethylene glycol having a weight average molecular weight of about 9000 can have mean particle mass of about 38 mg and standard deviation of mass of about 3 mg.

An individual particle may have a volume from about 0.003 cm³ to about 5 cm³. An individual particle may have a volume from about 0.003 cm³ to about 1 cm³. An individual particle may have a volume from about 0.003 cm³ to about 0.5 cm³. An individual particle may have a volume from about 0.003 cm³ to about 0.2 cm³. An individual particle may have a volume from about 0.003 cm³ to about 0.15 cm³. Smaller particles are thought to provide for better packing of the particles in a container and faster dissolution in the wash.

The composition can comprise particles that are retained on a number 10 sieve as specified by ASTM International, ASTM E11-13. The composition can comprise particles wherein more than about 50% by weight of the particles are retained on a number 10 sieve as specified by ASTM International, ASTM E11-13. The composition can comprise particles wherein more than about 70% by weight of the particles are retained on a number 10 sieve as specified by ASTM International, ASTM E11-13. The composition can comprise particles wherein more than about 90% by weight of the particles are retained on a number 10 sieve as specified by ASTM International, ASTM E11-13. It can be desirable to provide particles sized as such because particles retained on a number 10 sieve may be easier to handle than smaller particles.

The composition can comprise particles that are retained on a number 6 sieve as specified by ASTM International, ASTM E11-13. The composition can comprise particles wherein more than about 50% by weight of the particles are retained on a number 6 sieve as specified by ASTM International, ASTM E11-13. The composition can comprise particles wherein more than about 70% by weight of the particles are retained on a number 6 sieve as specified by ASTM International, ASTM E11-13. The composition can comprise particles wherein more than about 90% by weight of the particles are retained on a number 6 sieve as specified by ASTM International, ASTM E11-13. It can be desirable to provide particles sized as such because particles retained on a number 6 sieve may be easier to handle than smaller particles.

The composition can comprise particles that pass a sieve having a nominal sieve opening size of 22.6 mm. The composition can comprise particles that pass a sieve having a nominal sieve opening size of 22.6 mm and are retained on a sieve having a nominal sieve opening size of 0.841 mm. Particles having a size such that they are retained on a sieve having a nominal opening size of 22.6 mm may tend to have a dissolution time that is too great for a common wash cycle. Particles having a size such that they pass a sieve having a nominal sieve opening size of 0.841 mm may be too small to conveniently handle. Particles having a size within the aforesaid bounds may represent an appropriate balance between dissolution time and ease of particle handling.

Particles having the size disclosed herein can be substantial enough so that they do not readily become airborne when poured from a container, dosing cup, or other apparatus, into a wash basin or washing machine. Further, such particles as disclosed herein can be easily and accurately poured from a container into a dosing cup. So such particles make it easy for the consumer to control the amount of spores she delivers to the wash.

A plurality of particles may collectively comprise a dose for dosing to a laundry washing machine or laundry wash basin. A single dose of the particles may comprise from about 1 g to about 27 g of particles. A single dose of the particles may comprise from about 5 g to about 27 g, alternatively from about 13 g to about 27 g, alternatively from about 14 g to about 20 g, alternatively from about 15 g to about 19 g, alternatively from about 18 g to about 19 g, alternatively combinations thereof and any whole numbers of grams or ranges of whole numbers of grams within any of the aforementioned ranges. The individual particles forming the plurality of particles that can make up the dose can have a mass from about 1 mg to about 5000 mg, alternatively from about 5 mg to about 1000 mg, alternatively from about 5 mg to about 200 mg, alternatively from about 10 mg to about 100 mg, alternatively from about 20 mg to about 50 mg, alternatively from about 35 mg to about 45 mg, alternatively about 38 mg, alternatively combinations thereof and any whole numbers or ranges of whole numbers of mg within any of the aforementioned ranges. The plurality of particles can be made up of particles having different size, shape, and/or mass. The particles in a dose can each have a maximum dimension less than about 15 mm. Each of the particles in a dose can have a maximum dimension less than about 1 cm.

The particles disclosed herein can be conveniently employed to treat laundry articles during a laundry process. The particles should be used in combination with a laundry detergent. The steps of the process can be to provide such particles comprising the formulation components disclosed herein. A dose of the particles can be placed in a dosing cup. The dosing cup can be the closure of a container containing the particles. The dosing cup can be a detachable and attachable dosing cup that is detachable and attachable to a container containing the particles or to the closure of such container. The dose of particles in the dosing cup can be dispensed into a washing machine. The step of dispensing the particles in the washing machine can take place by pouring the particles into the washing machine or placing the dosing cup and the particles contained therein into the washing machine, preferably the particles are dosed into the drum of an automatic laundry machine.

### Carrier

The carrier can be or comprise a material selected from the group consisting of water soluble inorganic alkali metal salt, water-soluble alkaline earth metal salt, water-soluble organic alkali metal salt, water-soluble organic alkaline earth metal salt, water soluble carbohydrate, water-soluble silicate, water soluble urea, and any combination thereof. Alkali metal salts can be, for example, selected from the group consisting of salts of lithium, salts of sodium, and salts of potassium, and any combination thereof. Useful alkali metal salts can be, for example, selected from the group consisting of alkali metal fluorides, alkali metal chlorides, alkali metal bromides, alkali metal iodides, alkali metal sulfates, alkali metal bisulfates, alkali metal phosphates, alkali metal monohydrogen phosphates, alkali metal dihydrogen phosphates, alkali metal carbonates, alkali metal monohydrogen carbonates, alkali metal acetates, alkali metal citrates, alkali metal lactates, alkali metal pyruvates, alkali metal silicates, alkali metal ascorbates, and combinations thereof.

Alkali metal salts can be selected from the group consisting of, sodium fluoride, sodium chloride, sodium bromide, sodium iodide, sodium sulfate, sodium bisulfate, sodium phosphate, sodium monohydrogen phosphate, sodium dihydrogen phosphate, sodium carbonate, sodium hydrogen carbonate, sodium acetate, sodium citrate, sodium lactate, sodium tartrate, sodium silicate, sodium ascorbate, potassium fluoride, potassium chloride, potassium bromide, potassium iodide, potassium sulfate, potassium bisulfate, potassium phosphate, potassium monohydrogen phosphate, potassium dihydrogen phosphate, potassium carbonate, potassium monohydrogen carbonate, potassium acetate, potassium citrate, potassium lactate, potassium tartrate, potassium silicate, potassium, ascorbate, and combinations thereof. Sodium acetate, sodium carbonate and mixtures thereof are especially suitable for use herein. Alkaline earth metal salts can be selected from the group consisting of salts of magnesium, salts of calcium, and the like, and combinations thereof. Alkaline earth metal salts can be selected from the group consisting of alkaline metal fluorides, alkaline metal chlorides, alkaline metal bromides, alkaline metal iodides, alkaline metal sulfates, alkaline metal bisulfates, alkaline metal phosphates, alkaline metal monohydrogen phosphates, alkaline metal dihydrogen phosphates, alkaline metal carbonates, alkaline metal monohydrogen carbonates, alkaline metal acetates, alkaline metal citrates, alkaline metal lactates, alkaline metal pyruvates, alkaline metal silicates, alkaline metal ascorbates, and combinations thereof. Alkaline earth metal salts can be selected from the group consisting of magnesium fluoride, magnesium chloride, magnesium bromide, magnesium iodide, magnesium sulfate, magnesium phosphate, magnesium monohydrogen phosphate, magnesium dihydrogen phosphate, magnesium carbonate, magnesium monohydrogen carbonate, magnesium acetate, magnesium citrate, magnesium lactate, magnesium tartrate, magnesium silicate, magnesium ascorbate, calcium fluoride, calcium chloride, calcium bromide, calcium iodide, calcium sulfate, calcium phosphate, calcium monohydrogen phosphate, calcium dihydrogen phosphate, calcium carbonate, calcium monohydrogen carbonate, calcium acetate, calcium citrate, calcium lactate, calcium tartrate, calcium silicate, calcium ascorbate, and combinations thereof. Inorganic salts, such as inorganic alkali metal salts and inorganic alkaline earth metal salts, do not contain carbon. Organic salts, such as organic alkali metal salts and organic alkaline earth metal salts, contain carbon. The organic salt can be an alkali metal salt or an alkaline earth metal salt of sorbic acid (i.e., asorbate). Sorbates can be selected from the group consisting of sodium sorbate, potassium sorbate, magnesium sorbate, calcium sorbate, and combinations thereof.

The carrier can be or comprise a material selected from the group consisting of a water-soluble inorganic alkali metal salt, a water-soluble organic alkali metal salt, a water-soluble inorganic alkaline earth metal salt, a water-soluble organic alkaline earth metal salt, a water-soluble carbohydrate, a water-soluble silicate, a water-soluble urea, and combinations thereof. The carrier or water soluble-soluble carrier can be selected from the group consisting of sodium chloride, potassium chloride, calcium chloride, magnesium chloride, sodium sulfate, potassium sulfate, magnesium sulfate, sodium carbonate, potassium carbonate, sodium hydrogen carbonate, potassium hydrogen carbonate, sodium acetate, potassium acetate, sodium citrate, potassium citrate, sodium tartrate, potassium tartrate, potassium sodium tartrate, calcium lactate, water glass, sodium silicate, potassium silicate, dextrose, fructose, galactose, isoglucose, glucose, sucrose, raffinose, isomalt, xylitol, candy sugar, coarse sugar, and combinations thereof. In one embodiment, the carrier or water-soluble carrier can be sodium chloride. In one embodiment, the carrier or water-soluble carrier can be table salt.

The carrier can be or comprise a material selected from the group consisting of sodium bicarbonate, sodium sulfate, sodium carbonate, sodium formate, calcium formate, sodium chloride, sucrose, maltodextrin, corn syrup solids, corn starch, wheat starch, rice starch, potato starch, tapioca starch, clay, silicate, citric acid carboxymethyl cellulose, fatty acid, fatty alcohol, glyceryl diester of hydrogenated tallow, glycerol, and combinations thereof.

The carrier can be selected from the group consisting of water soluble organic alkali metal salt, water soluble inorganic alkaline earth metal salt, water soluble organic alkaline earth metal salt, water soluble carbohydrate, water soluble silicate, water soluble urea, starch, clay, water insoluble silicate, citric acid carboxymethyl cellulose, fatty acid, fatty alcohol, glyceryl diester of hydrogenated tallow, glycerol, polyethylene glycol, and combinations thereof.

The carrier can be selected from the group consisting of disaccharides, polysaccharides, silicates, zeolites, carbonates, sulfates, citrates, and combinations thereof.

Examples of water soluble polymers include but are not limited to polyvinyl alcohols (PVA), modified PVAs; polyvinyl pyrrolidone; PVA copolymers such as PVA/polyvinyl pyrrolidone and PVA/polyvinyl amine; partially hydrolyzed polyvinyl acetate; polyalkylene oxides such as polyethylene oxide; polyethylene glycols; acrylamide; acrylic acid; cellulose, alkyl cellulosics such as methyl cellulose, ethyl cellulose and propyl cellulose; cellulose ethers; cellulose esters; cellulose amides; polyvinyl acetates; polycarboxylic acids and salts; polyaminoacids or peptides; polyamides; polyacrylamide; copolymers of maleic/acrylic acids; polysaccharides including starch, modified starch; gelatin; alginates; xyloglucans, other hemicellulosic polysaccharides including xylan, glucuronoxylan, arabinoxylan, mannan, glucomannan and galactoglucomannan; and natural gums such as pectin, xanthan, and carrageenan, locus bean, arabic, tragacanth; and combinations thereof. Carrageenan has been found to be a very suitable carrier for use herein. In one embodiment the polymer comprises polyacrylates, especially sulfonated polyacrylates and water-soluble acrylate copolymers; and alkylhydroxy cellulosics such as methylcellulose, carboxymethylcellulose sodium, modified carboxy-methylcellulose, dextrin, ethylcellulose, propylcellulose, hydroxyethyl cellulose, hydroxypropyl methylcellulose, maltodextrin, polymethacrylates. In yet another embodiment the polymer comprises PVA; PVA copolymers; hydroxypropyl methyl cellulose (HPMC); and mixtures thereof.

The particles can comprise at least 40%, preferably at least 50% and 99.999% or less, by weight of the particles of the carrier. The particles can comprise from about 45% by weight to about 99.999% by weight of the particles of the carrier. The particles can comprise from about 45% by weight to about 99.99% by weight of the particles of the carrier.

Preferably, the carrier is polyethylene glycol (PEG). PEG can be a convenient material to employ to make particles because it can be sufficiently water soluble to dissolve during a wash cycle when the particles are within the aforesaid range of mass. Further, PEG can be easily processed as melt. The melt temperature of PEG can vary as a function of molecular weight of the PEG. The melt temperature of PEG, depending on molecular weight and or distribution of molecular weight, can be low enough such that when the particles comprising PEG and bacterial endospores are formed from a melt that includes PEG and the endospores, the activity of the endospores remains high enough to be able to decrease malodor of fabrics.

The particles can comprise more than about 40% by weight PEG having a weight average molecular weight from about 2000 to about 13000. PEG has a relatively low cost, may be formed into many different shapes and sizes, minimizes unencapsulated perfume diffusion, and dissolves well in water. PEG comes in various weight average molecular weights. A suitable weight average molecular weight range of PEG includes from about 2,000 to about 13,000, from about 4,000 to about 12,000, alternatively from about 5,000 to about 11,000, alternatively from about 6,000 to about 10,000, alternatively from about 7,000 to about 9,000, alternatively combinations thereof. PEG is available from BASF, for example PLURIOL E 8000.

The particles can comprise more than about 40% by weight of the particles of PEG. The particles can comprise more than about 50% by weight of the particles of PEG. The particles can comprise more than about 60% by weight of the particles of PEG. The particles may comprise from about 65% to about 99% by weight of the composition of PEG. The particles may comprise from about 40% to about 99% by weight of the composition of PEG. The particles may comprise from about 45% to about 99% by weight of the composition of PEG.

The plurality of particles can be substantially free from particles having a mass less than about 10 mg. This can be practical for limiting the ability of the particles to become airborne.

Depending on the application, the particles can comprise from about 0.5% to about 5% by weight of the particles of a balancing agent selected from the group consisting of glycerin, polypropylene glycol, isopropyl myristate, dipropylene glycol, 1,2-propanediol, and PEG having a weight average molecular weight less than 2,000, and mixtures thereof. The balancing agent can be practical for providing particles having the same processing characteristics even though the particles have different formulations. For instance, two different scent variants of a product may have different levels of perfume. With use of a balancing agent, the PEG level can be the same in each scent variant and the formulas can be balanced with the balancing agent. This can make processing simpler in that the formulas for the scent variants will have the same level of PEG and may have similar processing characteristics.

The particles can comprise an antioxidant. The antioxidant can help to promote stability of the color and or odor of the particles over time between production and use. The particles can comprise between about 0.01% to about 1% by weight antioxidant. The particles can comprise between about 0.001% to about 2% by weight antioxidant. The particles can comprise between about 0.01% to about 0.1% by weight antioxidant. The antioxidant can be butylated hydroxytoluene.

### Dye

The particles may comprise dye. The dye may include those dyes that are typically used in laundry detergent or fabric softeners. The fabric treatment composition may comprise less than about 0.1%, alternatively about 0.001% to about 0.1%, alternatively about 0.01% to about 0.02%, alternatively combinations thereof and any hundredths of percent or ranges of hundredths of percent within any of the aforementioned ranges, of dye by weight of the particles of fabric treatment composition. Examples of suitable dyes include, but are not limited to, LIQUITINT PINK AM, AQUA AS CYAN 15, and VIOLET FL, available from Milliken Chemical. Employing a dye can be practical to help the user differentiate between particles having differing scents.

### Perfume

In addition to the carrier, particle A further comprises from about 0.1% to about 10%, preferably from about 0.5% to about 5% by weight of particle A of perfume. Preferably the perfume is in the form of free perfume. The perfume can be unencapsulated perfume, encapsulated perfume, perfume provided by a perfume delivery technology, or a perfume provided in some other manner. Perfumes are generally described in U.S. Pat. No. 7,186,680 at column 10, line 56, to column 25, line 22. The particles can comprise unencapsulated perfume and are essentially free of perfume carriers, such as a perfume microcapsules. The particles can comprise perfume carrier materials (and perfume contained therein). Examples of perfume carrier materials are described in U.S. Pat. No. 7,186,680, column 25, line 23, to column 31, line 7. Specific examples of perfume carrier materials may include cyclodextrin and zeolites.

Particle A can comprise about 0.1% to about 10%, alternatively about 1% to about 8%, alternatively 2% to about 5%, alternatively combinations thereof and any whole percentages within any of the aforementioned ranges, of perfume by weight of particle A. Particle A can comprise from about 0.1% by weight to about 6% by weight of the particles of perfume. The perfume can be free perfume and or encapsulated perfume.

Particle A is “substantially free” or preferably free of Bacillus spores and enzymes. By “substantially free” of Bacillus spores and enzymes is herein meant that of Bacillus spores and enzymes have not been purposely added to particle A. It means that particle A preferably comprises less than 0.0001% by weight of particle A of Bacillus spores and enzymes.

The particles can comprise unencapsulated perfume and perfume microcapsules. The particles may comprise about 0.1% to about 20%, alternatively about 1% to about 15%, alternatively from about 2% to about 10%, alternatively combinations thereof and any whole percentages or ranges of whole percentages within any of the aforementioned ranges, of the unencapsulated perfume by weight of the particles. Such levels of unencapsulated perfume can be appropriate for any of the particles disclosed herein that have unencapsulated perfume.

As described in more detail below, the perfume may comprise neat perfume, encapsulated perfume, or mixtures thereof. Preferably, the perfume comprises neat perfume. A portion of the perfume may be encapsulated in a core-shell encapsulate.

As used herein, the term “perfume” encompasses the perfume raw materials (PRMs) and perfume accords. The term “perfume raw material” as used herein refers to compounds having a molecular weight of at least about 100 g/mol and which are useful in imparting an odor, fragrance, essence or scent, either alone or with other perfume raw materials. As used herein, the terms “perfume ingredient” and “perfume raw material” are interchangeable. The term “accord” as used herein refers to a mixture of two or more PRMs.

Typical PRM comprise inter alia alcohols, ketones, aldehydes, esters, ethers, nitrites and alkenes, such as terpene. Preferably, the perfume comprises at least 5% by weight of the perfume of aldehydes, ketones, and mixtures thereof. More preferably, the perfume comprises at least 20%, more preferably from 20% to 40% by weight of the perfume of aldehydes, ketones, and mixtures thereof. A listing of common PRMs can be found in various reference sources, for example, “Perfume and Flavor Chemicals”, Vols. I and II; Steffen Arctander Allured Pub. Co. (1994) and “Perfumes: Art, Science and Technology”, Miller, P. M. and Lamparsky, D., Blackie Academic and Professional (1994).

The PRMs are characterized by their boiling points (B.P.) measured at the normal pressure (760 mm Hg), and their octanol/water partitioning coefficient (P). Based on these characteristics, the PRMS may be categorized as Quadrant I, Quadrant II, Quadrant III, or Quadrant IV perfumes, as described in more detail below.

Octanol/water partitioning coefficient of a PRM is the ratio between its equilibrium concentration in octanol and in water. The log P of many PRMs has been reported; for example, the Pomona92 database, available from Daylight Chemical Information Systems, Inc. (Daylight CIS), Irvine, Calif., contains many, along with citations to the original literature. However, the log P values are most conveniently calculated by the “C LOG P” program, also available from Daylight CIS. This program also lists experimental log P values when they are available in the Pomona92 database. The “calculated log P” (C log P) is determined by the fragment approach on Hansch and Leo (cf., A. Leo, in Comprehensive Medicinal Chemistry, Vol. 4, C. Hansch, P. G. Sammens, J. B. Taylor and C. A. Ransden, Eds., p. 295, Pergamon Press, 1990, incorporated herein by reference). The fragment approach is based on the chemical structure of each PRM, and takes into account the numbers and types of atoms, the atom connectivity, and chemical bonding. The C log P values, which are the most reliable and widely used estimates for this physicochemical property, are preferably used instead of the experimental log P values in the selection of PRMs which are useful in the present invention.

The boiling points of many PRMs are given in, e.g., “Perfume and Flavor Chemicals (Aroma Chemicals),” S. Arctander, published by the author, 1969, incorporated herein by reference. Other boiling point values can be obtained from different chemistry handbooks and databases, such as the Beilstein Handbook, Lange's Handbook of Chemistry, and the CRC Handbook of Chemistry and Physics. When a boiling point is given only at a different pressure, usually lower pressure than the normal pressure of 760 mm Hg, the boiling point at normal pressure can be approximately estimated by using boiling point-pressure nomographs, such as those given in “The Chemist's Companion,” A. J. Gordon and R. A. Ford, John Wiley & Sons Publishers, 1972, pp. 30-36.

The perfume of the invention preferably comprises at least 20% by weight of the perfume of aldehydes and ketones.

Perfume raw materials having a B.P. lower than 250° C. and a C log P lower than 3.0 are called Quadrant I perfumes. Quadrant I perfumes having a B.P. lower than 250° C. and a C log P between 0 and 3.0 are preferred. Non-limiting examples of Quadrant I perfume raw materials include Allyl Caproate, Arnyl Acetate, Arnyl Propionate, Anisic Aldehyde, Anisole, Benzaldehyde, Benzyl Acetate, Benzyl Acetone, Benzyl Alcohol, Benzyl Formate, Benzyl Iso Valerate, Benzyl Propionate, Beta Gamma Hexenol, Camphor Gum, laevo-Carveol, d-Carvone, laevo-Carvone, Cinnamic Alcohol, Cinnarnyl Formate, cis-Jasmone, cis-3-Hexenyl Acetate, Curninic, alcohol, Cuminic aldehyde, Cyclal C, Dimethyl Benzyl Carbinol, Dimethyl Benzyl Carbinyl Acetate, Ethyl Acetate, Ethyl Aceto Acetate, Ethyl Amyl Ketone, Ethyl Benzoate, Ethyl Butyrate, Ethyl Hexyl Ketone, Ethyl Phenyl Acetate, Eucalyptol, Eugenol, Fenchyl Alcohol, Flor Acetate (tricyclo Decenyl Acetate), Frutene (tricyclo Decenyl Propionate), Geraniol, Hexenol, Hexenyl Acetate, Hexyl Acetate, Hexyl Formate, Hydratropic Alcohol, Hydroxycitronellal, Isoarnyl Alcohol, Isomenthone, Isopulegyl Acetate, Isoquinoline, cis jasmone, Ligustral, Linalool, Linalool Oxide, Linalyl Formate, Menthone, Methyl Acetophenone, Methyl Arnyl Ketone, Methyl Anthranilate, Methyl Benzoate, Methyl Benzyl Acetate, nerol, phenyl ethyl alcohol, alpha-terpineol, Propanoic acid ethyl ester, Ethyl Propionate, Acetic acid 2-methylpropyl ester, Isobutyl Acetate, Butanoic acid 2-methyl-ethyl ester, Ethyl-2-Methyl Butyrate, 2-Hexenal, (E)-, 2-Hexena,l Benzeneacetic acid methyl ester, Methyl Phenyl Acetate, 1,3-Dioxolane-2-acetic acid 2-methyl-ethyl ester, Fructone, Benzeneacetaldehyde .alpha.-methyl-, Hydratropic Aldehyde, Acetic acid (2-methylbutoxy)-2-propenyl ester, Allyl Amyl Glycolate, Ethanol 2,2′-oxybis-, Calone 161, 2(3H)-Furanone 5-ethyldihydro-, Gamma Hexalactone, 2H-Pyran 3,6-dihydro-4-methyl-2-(2-methyl-1-propenyl)-, Nerol Oxide, 2-Propenal 3-phenyl-, Cinnamic Aldehyde, 2-Propenoic acid 3-phenyl-methyl ester, Methyl Cinnamate, 4H-Pyran-4-one 2-ethyl-3-hydroxy-, Ethyl Maltol, 2-Heptanone, Methyl Amyl Ketone, Acetic acid pentyl ester, Iso Amyl-Acetate, Heptenone methyl-, Methyl Heptenone, 1-Heptanol, Heptyl Alcohol, 5-Hepten-2-one 6-methyl-, Methyl Heptenone, Ethanol 2-(2-methoxyethoxy)-, Veramoss Sps, Tricyclo[2.2.1.02,6]heptane 1-ethyl-3-methoxy-, Neoproxen, Benzene 1,4-dimethoxy-, Hydroquinone Dimethyl Ether, Carbonic acid 3-hexenyl methyl ester (Z)-, Liffarome, Oxirane 2,2-dimethyl-3-(3-methyl-2,4-pentadienyl)-, Myroxide, Ethanol 2-(2-ethoxyethoxy)-, Diethylene Glycol Mono Ethylether, Cyclohexaneethanol, Cyclohexyl Ethyl Alcohol, 3-Octen-1-ol (Z)-, Octenol Dix, 3-Cyclohexene-1-carboxaldehyde 3,6-dimethyl-, Cyclovertal, 1,3-Oxathiane 2-methyl-4-propyl-cis-, Oxane, Acetic acid 4-methylphenyl ester, Para Cresyl Acetate, Benzene (2,2-dimethoxyethyl)-, Phenyl Acetaldehyde Dimethyl Acetal, Octanal 7-methoxy-3,7-dimethyl-, Methoxycitronellal Pq, 2H-1-Benzopyran-2-one octahydro-, Octahydro Coumarin, Benzenepropanal .beta.-methyl-, Trifemal, 4,7-Methano-1H-indenecarboxaldehyde octahydro-, Formyltricyclodecan, Ethanone 1-(4-methoxyphenyl)-, Para Methoxy Acetophenone, Propanenitrile 3-(3-hexenyloxy)-(Z)-, Parmanyl, 1,4-Methanonaphthalen-5(1H)-one 4,4a,6,7,8,8a-hexahydro-, Tamisone, Benzene [2-(2-propenyloxy)ethyl]-, LRA 220, Benzenepropanol, Phenyl Propyl Alcohol, 1H-Indole, Indole, 1,3-Dioxolane 2-(phenylmethyl)-, Ethylene Glycol Acetal/Phenyl Acetaldehyde, 2H-1-Benzopyran-2-one 3,4-dihydro-, Dihydrocoumarin, and mixtures thereof.

Perfume raw materials having a B.P. of about 250° C. or higher and a C log P lower than 3.0 are called Quadrant II perfumes. Quadrant II perfumes having a B.P. higher than 250° C. and a C log P between 0 and 3.0 are preferred. Non-limiting examples of Quadrant II perfume raw materials include coumarin, eugenol, iso-eugenol, indole, methyl cinnamate, methyl dihydrojasmonate, methyl-N-methyl anthranilate, beta-methyl naphthyl ketone, delta-Nnonalactone, vanillin, and mixtures thereof.

Perfume raw materials having a B.P. less than 250° C. and a C log P higher than about 3.0 are called Quadrant III perfumes. Non-limiting examples of Quadrant III perfume raw materials include iso-bomyl acetate, carvacrol, alpha-citronellol, paracymene, dihydro myrcenol, geranyl acetate, d-limonene, linalyl acetate, vertenex.

Perfume raw materials having a B.P. of about 250° C. or higher and a C log P of about 3.0 or higher are called Quadrant IV perfumes or enduring perfumes. Non-limiting examples of enduring perfume raw materials include allyl cyclohexane propionate, ambrettolide, amyl benzoate, amyl cinnamate, amyl cinnamic aldehyde, amyl cinnamic aldehyde dimethyl acetal, iso-amyl salicylate, hydroxycitronellal-methyl anthranilate (known as Aurantiol®), benzophenone, benzyl salicylate, para-tert-butyl cyclohexyl acetate, iso-butyl quinoline, beta-caryophyllene, cadinene, cedrol, cedryl acetate, cedryl formate, cinnamyl cinnamate, cyclohexyl salicylate, cyclamen aldehyde, dihydro isojasmonate, diphenyl methane, diphenyl oxide, dodecalactone, 1-(1,2,3,4,5,6,7,8-octahydro-2,3,8,8-tetramethyl-2-naphthalenyl)-ethanone (known as iso E Super®), ethylene brassylate, methyl phenyl glycidate, ethyl undecylenate, 15-hydroxypentadecanoic acid lactone (known as Exaltolide®), 1,3,4,6,7,8-hexahydro-4,6,6,7,8,8-hexamethyl-cyclopenta-gamma-2-benzopyran (known as Galaxolide®), geranyl anthranilate, geranyl phenyl acetate, hexadecanolide, hexenyl salicylate, hexyl cinnamic aldehyde, hexyl salicylate, alpha-irone, gamma-ionone, gamma-n-methyl ionone, para-tertiary-butyl-alpha-methyl hydrocinnamic aldehyde (known as Lilial®), lilial (p-t-bucinal)®, linalyl benzoate, 2-methoxy naphthalene, methyl dihydrojasmone, musk indanone, musk ketone, musk tibetine, myristicin, oxahexadecanolide-10, oxahexadecanolide-11, patchouli alcohol, 5-acetyl-1,1,2,3,3,6-hexamethylindan (known as Phantolide®), phenyl ethyl benzoate, phenylethylphenylacetate, phenyl heptanol, phenyl hexanol, alpha-santalol, delta-undecalactone, gamma-undecalactone, vetiveryl acetate, yara-yara, ylangene.

The perfume raw materials and accords may be obtained from one or more of the following perfume material suppliers Firmenich (Geneva, Switzerland), Givaudan (Argenteuil, France), IFF (Hazlet, N.J.), Quest (Mount Olive, N.J.), Bedoukian (Danbury, Conn.), Sigma Aldrich (St. Louis, Mo.), Millennium Specialty Chemicals (Olympia Fields, Ill.), Polarone International (Jersey City, N.J.), Fragrance Resources (Keyport, N.J.), and Aroma & Flavor Specialties (Danbury, Conn.).

Traditionally, perfume accords are formulated around “enduring” perfumes (Quadrant IV) due to their high deposition efficiency hence odor impact on fabrics, while “non-enduring” perfumes, especially Quadrant I perfume ingredients, are considered difficult to deposit onto fabrics and as such typically are used solely in very low amount to minimize waste and pollution. Quadrant I perfume ingredients are hydrophilic (e.g., a C log P lower than 3.0) and have low boiling points (e.g., a B.P. lower than 250° C.); thus, they are easily lost to the wash or rinse medium or during heat drying. In compositions of the present disclosure, some non-enduring perfume ingredients, especially Quadrant I perfume ingredients, may be intentionally formulated, e.g., to improve the perfume odor in the headspace of the container to enable consumers to appreciate the perfume character of the contained water soluble pouches. As described below, compositions of the present disclosure may include at least about 2%, or at least about 3%, or at least about 4%, by weight of the composition, of Quadrant I perfume ingredients.

Perfume according to the present disclosure may contain from about 15% to about 60%, preferably from about 20% to about 55%, more preferably from about 25% to about 50% by weight of the perfume accord of non-enduring perfume ingredients. Non-enduring perfume ingredients encompass Quadrant I, II and III perfume ingredients. Perfume according to the present disclosure may contain from about 2% to about 15%, preferably from about 3% to about 12%, more preferably from about 4% to about 10% by weight of the perfume accord of Quadrant I perfume ingredients. The perfume may include at least about 2%, or at least about 3%, or at least about 4%, by weight of the composition, of Quadrant I perfume ingredients.

Additionally or alternatively, the perfume may include from about 2.5% to about 25%, preferably from about 3% to about 20%, more preferably from about 5% to about 15% of Quadrant II perfume ingredients, from about 10% to about 50%, preferably from about 15% to about 45%, more preferably from about 20% to about 40% of Quadrant III perfume ingredients, and/or from about 40% to about 85%, preferably from about 45% to about 75%, more preferably from about 40% to about 65% of Quadrant IV perfume ingredients. Such perfume accords have been found, when co-formulated with organic solvents into household care compositions enclosed in the water soluble film according to the present disclosure to form water soluble pouches according to the present disclosure, to deliver good perfume odor in the headspace of the container to enable consumers to appreciate the perfume character of the contained water soluble pouches, while still delivering efficient perfume on fabrics deposition through the wash hence great odor impact on fabrics at both wet and dry stage, and minimizing organic solvent loss upon storage.

The particles can comprise encapsulated perfume. Encapsulated perfume can be provided as plurality of perfume microcapsules. A perfume microcapsule is perfume oil enclosed within a shell. The shell can have an average shell thickness less than the maximum dimension of the perfume core. The perfume microcapsules can be friable perfume microcapsules. The perfume microcapsules can be moisture activated perfume microcapsules.

The perfume microcapsules can comprise a melamine/formaldehyde shell. Perfume microcapsules may be obtained from Appleton, Quest International, or International Flavor & Fragrances, or other suitable source. The perfume microcapsule shell can be coated with polymer to enhance the ability of the perfume microcapsule to adhere to fabric. This can be desirable if the particles are designed to be a fabric treatment composition. The perfume microcapsules can be those described in U.S. Patent Pub. 2008/0305982.

The particles can comprise about 0.1% to about 20%, alternatively about 0.1% to about 10%, alternatively about 1% to about 15%, alternatively 2% to about 10%, alternatively combinations thereof and any whole percentages within any of the aforementioned ranges, of encapsulated perfume by weight of the particles.

The particles can comprise perfume microcapsules but be free of or essentially free of unencapsulated perfume. The particles may comprise about 0.1% to about 20%, alternatively about 1% to about 15%, alternatively about 2% to about 10%, alternatively combinations thereof and any whole percentages within any of the aforementioned ranges, of encapsulated perfume by weight of the particles.

### Method of Making Particles

The particles of the invention can be made using a similar process to that described in WO2017/156095 A1, page 18, line 14 to page 21, line 3.

### Example

The following example compares the colour stability of various polyethylene glycol bead compositions designed to supplement a detergent by addition to a laundry washing process. The results conclude that integration of bioactive ingredients Bacillus spores and enzymes together with perfume in the same bead leads to poor colour stability. Thus, superior colour stability can be achieved by separation of the bioactive ingredient from perfume in separate beads within the same composition.

### Bead and Stability Test Method

The bead examples were prepared with the following compositions (Table 1):

TABLE 1

| | | Perfume | | Bacillus |
|---|---|---|---|---|
| | PEG | model | Lipex | spore |
| | 8000 | accord | 100L | premix |
| | % | % | % | % |
| A - PEG | 100 | — | — | — |
| B - PEG/perfume | 90 | 10 | — | — |
| C - PEG/enzyme/Bacillus spores | 98.8 | — | 1 | 0.2 |
| D - PEG/perfume/enzyme/ | 88.8 | 10 | 1 | 0.2 |
| Bacillus spores | | | | |

The model perfume accord consisted of the following perfume raw materials:

| Perfume raw material | Level (%) |
|---|---|
| ALLYL AMYL GLYCOLATE | 1.500 |
| AMBRETTOLIDE | 2.000 |
| AMBRONAT | 0.600 |
| AMYL PROPIONATE | 1.500 |
| ANISYL ACETATE | 1.000 |
| BENZYL ACETATE | 6.000 |
| BETA GAMMA HEXENOL | 1.000 |
| BETA NAPHTHOL METHYL ETHER | 2.000 |
| CINNAMIC ALDEHYDE | 0.400 |
| CITRAL | 2.000 |
| CITRONELLYL NITRILE | 2.000 |
| CLONAL | 0.400 |
| CORANOL | 5.000 |
| CYCLOHEXYL SALICYLATE | 5.100 |
| DELTA DAMASCONE | 1.500 |
| DELTA OCTALACTONE FCC | 0.600 |
| DIPENTENE | 7.000 |
| ETHYL BUTYRATE | 0.400 |
| ETHYL MALTOL | 0.600 |
| ETHYL-2-METHYL BUTYRATE | 1.500 |
| ETHYLENE BRASSYLATE | 5.000 |
| EUCALYPTOL | 3.000 |
| EUGENOL | 0.600 |
| FLORHYDRAL | 1.500 |
| GERANIOL | 6.000 |
| HELIOTROPIN | 1.500 |
| HEXYL ACETATE | 2.000 |
| IONONE BETA | 4.000 |
| ISO BORNYL ACETATE | 4.000 |
| ISO E SUPER OR WOOD | 4.000 |
| LACTOJASMON | 0.400 |
| LINALYL ACETATE | 5.000 |
| METHYL BETA-NAPHTHYL KETONE | 1.500 |
| METHYL DIHYDRO JASMONATE | 3.900 |
| METHYL NONYL ACETALDEHYDE | 1.500 |
| METHYL SALICYLATE USP | 0.600 |
| PEONILE | 3.000 |
| PHENYL ETHYL ALCOHOL | 5.000 |
| PHENYL ETHYL DIMETHYL | 2.000 |
| CARBINOL | |
| PRENYL ACETATE | 1.000 |
| STRAWBERIFF | 0.400 |
| VANILLIN | 2.000 |

Carbowax™ Polyethylene Glycol 8000 (PEG 8000) (DOW Inc., Midland, MI, USA) was melted to 80° C. and spread into a warmed silicone bead mould (3 mm diameter) and left to cool at room temperature.

Additional batches of molten PEG8000 were weighed into individual Speedmixer cups and levels of perfume model accord, Lipex 100L (Novonesis, Denmark), and Bacillus spore premix (Genesis Biosciences, Cardiff, UK) were added, according to table 1.

The compositions were mixed using a Speedmixer DAC150 (Hauschild, MI, USA) for 1 minute at 2400 rpm, before being spread into a silicone bead mold and left to cool at room temperature.

All solidified beads were popped out of the bead molds, before 10 g of each bead mixture was weighed out into sterile 90 mm Petri dishes and stored in a controlled humidity oven (Memmert, Schwabach, Germany) at 40° C., 50% relative humidity (RH).

After 8 days, L*a*b* measurements in D65 were taken using a DigiEye (VeriVide Ltd, Leicester, UK) at shutter speed ½, radius 180 which was calibrated before use, by imaging directly down into the Petri dish of beads and taking four measurements. Hunter Whiteness Index (Hunter WI) values were calculated from the L*a*b* values of the reference (nil spore) vs the test legs, using the following calculation:

$$Hunter WI = L - 3 b$$

| | Mean L* | Mean a* | Mean b* | Mean Hunter WI |
|---|---|---|---|---|
| 40° C. storage, 8 days | value | value | value | (St dev) |
| A - PEG reference | 95.06 | −1.19 | 4.02 | 83.46 (0.59) BD* |
| B - PEG/perfume | 91.41 | 0.14 | 8.77 | 65.11 (0.35) ACD* |
| C - PEG/enzyme/Bacillus spores | 94.92 | −1.33 | 3.82 | 83.46 (0.34) BD* |
| D - PEG/perfume/enzyme/Bacillus | 90.16 | 1.50 | 11.89 | 54.76 (1.81) ABD* |
| spores | | | | |

*Letters in bold indicate significant differences in Hunter WI values as determined by Tukey-Kramer HSD (p-value = <0.0001).

The PEG beads containing perfume, enzyme, and Bacillus spores (D) showed a significant difference in Hunter WI value vs the PEG reference (A), PEG beads with perfume (B), and PEG beads with enzymes and Bacillus spores (C). The differences were highly noticeable to the eye.

Addition of perfume to a PEG bead containing enzyme and Bacillus spores shows a significantly greater shift in Hunter WI (B vs D) than addition of perfume to PEG alone (A vs C). The differences were highly noticeable to the eye.

Thus, superior colour stability can be achieved by substantially separating the bioactive ingredients (enzymes/Bacillus spores) from perfume into separate beads within the detergent additive beads composition.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A particulate laundry additive composition comprising a plurality of particles wherein each of said particles has a mass between about 1 mg to about 5000 mg, the composition comprising:
i) at least about 60% by weight of the composition of particle A, wherein particle A comprises at least about 40% by weight of the particle of a carrier, from about 0.1% to about 10% by weight of the particle of perfume and the particle is substantially free of Bacillus spores and enzymes; and
ii) at least about 2% by weight of the composition of particle B, wherein particle B comprises at least about 40% by weight of the particle of a carrier, from about 0.0001% to about 5% by weight of the particle of Bacillus spores and enzymes and less than about 0.01% by weight of the particle of perfume.

2. The composition according to claim 1 wherein at least about 50% by weight of the perfume in particle A is in the form of free perfume and wherein the perfume comprises from about 20% to about 40% by weight of the perfume of aldehydes and ketone perfume raw materials.

3. The composition according to claim 1 wherein particle A comprises perfume capsules.

4. The composition according to claim 1 wherein particle B comprises from about 1×10³ to about 1×10¹¹ CFU/g of particle B of Bacillus spores.

5. The composition according to claim 1 wherein the Bacillus spores comprise bacteria selected from the group consisting of Bacillus sublilis, Bacillus amyloliquefiaciens, Bacillus licheniformis, Bacillus inegaterium, Bacillus pumilus, Bacillus thuringiensis, Bacillus coagulans, and mixtures thereof.

6. The composition according to claim 1 wherein particle B comprises from about 0.001% to about 4.5% by weight of particle B of enzymes.

7. The composition according to claim 1 wherein the enzyme is selected from the group consisting of proteases, amylases, cellulases, lipases, xyloglucanases, mannanases, nucleases, pectate lyases, and a mixture thereof.

8. The composition according to claim 1 wherein the carrier comprises a material selected from the group consisting of water soluble polyalkylene glycol, sucrose, bentonite, water soluble organic alkali metal salt, water soluble inorganic alkaline earth metal salt, water soluble organic alkaline earth metal salt, water soluble carbohydrate, water soluble silicate, water soluble urea, starch, clay, water insoluble silicate, citric acid, glycolic acid, carboxymethyl cellulose, fatty acid, fatty alcohol, glyceryl diester of hydrogenated tallow, glycerol, polyethylene glycol, polyvinyl alcohol and combinations thereof.

9. The composition according to claim 1 wherein the carrier comprises a material selected from the group consisting of water-soluble polyalkylene glycol, water-soluble alkali metal salts, and mixtures thereof.

10. The composition according to claim 1 wherein the carrier comprises polyethylene glycol, wherein said polyethylene glycol has a weight average molecular weight from about 2000 to about 13000.

11. The composition according to claim 1 wherein the carrier comprises a water-soluble salt selected the group consisting of sodium acetate, sodium carbonate and mixtures thereof.

12. The composition according to claim 1 wherein the carrier comprises carrageenan.

13. The composition according to claim 1 wherein the plurality of particles is substantially free from particles having a mass of less than about 1 mg.

14. A product comprising a container and a composition according to claim 1.

15. A process for treating soiled laundry articles comprising the steps of:
treating the articles with a detergent composition; and with a composition according to claim 1.
